(19) United States
(12) Patent Application Publication
(10) Pub. No.: US 2009/0146828 A1
(43) Pub. Date: Jun. 11, 2009

(54) MECHANICAL LIFT MAINTENANCE INDICATION SYSTEM

(75) Inventors: Lawrence Eschelbacher, Marcellus, NY (US); Michael Murphy, Baldwinsville, NY (US); Robert J. Theis, JR., Manlius, NY (US)

Correspondence Address: BOND, SCHOENECK & KING, PLLC, ONE LINCOLN CENTER, SYRACUSE, NY, 13202-1355, US

(73) Assignee: J. R. CLANCY, INC., Syracuse, NY (US)

(21) Appl. No.: 12/329,920

(22) Filed: Dec. 8, 2008

Related U.S. Application Data
(60) Provisional application No. 60/992,861, filed on Dec. 6, 2007.

(51) Int. Cl. G08B 21/00

(52) U.S. Cl. 340/679

(57) ABSTRACT

A theatrical lift including a timer and an indicator light. The light indicates a need for maintenance after a predetermined amount of time passes as measured by the timer. Also, a lift, such as a theatrical lift, including an indicator, a reset switch and an indicator housing. The indicator is located on the indicator housing. The reset switch is located inside of the indicator housing. The indicator housing can be opened or partially opened to allow selective access to the reset switch. In this way, the reset switch can be easily reset by a lift maintenance technician as part of performing routine maintenance on the lift, but will not be easily reset by a lift operator as a casual matter.

### RELATED APPLICATION

The present application claims priority to U.S. provisional patent application No. 60/992,861, filed on Dec. 6, 2007; all of the foregoing patent-related document(s) are hereby incorporated by reference herein in their respective entirety(ies).

### BACKGROUND OF THE INVENTION

1. Field of the Invention

The present invention relates to theatrical lifts (see DEFINITIONS section) and more particularly to maintenance of theatrical lifts.

2. Description of the Related Art

Mechanical lifts, winches and the like are conventional. Older designs were generally human powered and counterweight assisted. More recent designs are generally motorized. It is conventionally recognized that these devices require maintenance, including both routine periodic maintenance, and non-routine maintenance upon observance of a fault condition. As an example, of routine maintenance, certain lift components may be recommended to be checked by professional at predetermined time periods. As examples of non-routine maintenance, some fault conditions requiring non-routine maintenance might be visible damage, a wholly or partially inoperative lift or an unusual noise heard during operation.

US patent application 2004/0263100 (“Heravi”) discloses a solid state controller for a winch that includes fault detection for several parameters. In the Heravi system, an indicator light indicates when there is some type of fault. Heravi states: “If a major fault occurs, the winch motor 12 will be stopped and the indicator light 58 will begin to transmit a sequence of blinks. These blinks will indicate what type of fault has occurred. The indicator light 58 will blink a certain number of times to give a fault code. After blinking, the fault code, the indicator light will pause and then repeat the process. For example, two blinks can be utilized to represent motor over-temperature, three blinks for over-load interrupt, four blinks for module over-temperature, five blinks for battery voltage too low or too high, six blinks for wiring and/or power module switch fault, and seven blinks for module over current.” These are all fault conditions that call for non-routine maintenance.

US patent application 2007/0205405 (“Stockmaster”) discloses an electric lift actuator. The Stockmaster actuator includes remote diagnostic capability that enables remote configuration as well as remote troubleshooting of the lift. Stockmaster further states: “[T]he pendant is fitted with a liquid crystal display (LCD) or similar display technology in order to provide the ability to communicate more readily-available information to a user. The information displayed in the LCD may include basic information such as system status (i.e.: system ready for use), advanced or optional information such as load weight, system usage and service information (i.e.: number of cycles completed and system service indicators) as well as enhanced guidance and feedback when in programming mode such as what feature is currently being programmed (i.e.: virtual limits). By using the LCD it is possible to provide more and different information to the installer, the user and even maintenance staff Once again, as an alternative to the LCD display, conventional light-emitting diodes (LEDs) and the like may be employed to communicate actuator status information to an operator.” (reference numerals omitted) It is noted that Stockmaster is not disclosed to relate to theatrical lifts. It is further noted that Stockmaster apparently bases its system service indicators on number of cycles because it describes its “service information” a “i.e.: number of cycles completed and system service indicators.”

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

One aspect of the present invention is directed to a theatrical lift including a timer and an indicator (see DEFINITIONS section) where the indicator indicates a need for maintenance after a predetermined amount of time passes as measured by the timer. Preferably, the lift further includes a reset mechanism that allows the timer and indicator to be reset when maintenance is performed pursuant to an initial indication by the indicator.

Another aspect of the present invention is directed to a lift, such as a theatrical lift, including an indicator, a reset mechanism and an indicator housing. The indicator is located in proximity to the indicator housing (for example, on the surface of the indicator housing). The reset mechanism is located inside of the indicator housing. The indicator housing can be moved between a non-access position and an access position. When the indicator housing is in the non-access position, the reset mechanism cannot be accessed from outside of the indicator housing. When the indicator housing is in the access position, the reset mechanism can be accessed (for example, by a tool, by a finger) from outside of the indicator housing. In some preferred embodiments, special tools are required to move the indicator housing from the non-access position into the access position so that access to the reset mechanism is limited to individuals who have the special tools (see DEFINITIONS section).

Another aspect of the present invention is a lift including maintenance detection module and a lift performance limiting module. The maintenance detection module detects that lift maintenance should be performed. For example, this detection may be based on passage of a predetermined amount of time, number of lift cycles, a time integral of force exerted by the lift and/or the like. When the maintenance detection module detects that lift maintenance should be performed, the lift performance limiting module limits performance of the lift in some way. There are many ways that lift performance should be limited. To name some examples: (i) lift start up time could be increased so that it takes longer to start using the lift after it is turned on; (ii) lift shut down time could be increased so that it takes longer for the lift to completely power down after it is shut off; (iii) delay intervals could be added to non-emergency manual operations of the lift so that the lift responds less quickly to non-emergency operator commands; (iv) range of lift motion could be limited; (v) maximum load could be limited; (vi) maximum speed could be limited; and/or (vii) rendering the lift completely inoperable. In some preferred embodiments the lift performance limiting module progressively limits lift performance more and more with continued lift usage after it has been determined that maintenance is required—in this way, the degree of limitation of lift performance will be correlated with the urgency of the need for lift maintenance. For example, a delay injected into non-emergency command responsiveness can be made hardly noticeable at first, but gradually progressing to the point where the operator realizes that she must get that maintenance done. By limiting the lift performance (short of completely disabling the lift), a compromise may be achieved between the desire to continue to use the lift (for example, in an ongoing theatrical performance) and the important need to do maintenance for safety and efficiency reasons.

Other aspects of the present invention may include the following: (i) a mechanical lift including a timer and an indicator (for example, an indicator light, a computer network communication), where the indicator is adapted and/or programmed make an indication after a predetermined time interval to thereby indicate that the mechanical lift should receive routine maintenance; (ii) a mechanical lift including a lift usage measuring device and an indicator, where the indicator is adapted and/or programmed to make an indication based on an amount of lift usage measured by the lift usage measuring device to thereby indicate that the mechanical lift should receive routine maintenance; (iii) a mechanical lift including a timer and a maintenance encouragement device, where the maintenance encouragement device is adapted and/or programmed to modify operability of the lift in order to encourage routine maintenance after a predetermined time interval; and/or (iv) a mechanical lift including a lift usage measuring device and a maintenance encouragement device, where the maintenance encouragement device is adapted and/or programmed to modify operability of the lift in order to encourage routine maintenance based on an amount of lift usage measured by the lift usage measuring device.

Various embodiments of the present invention may exhibit one or more of the following objects, features and/or advantages:

(i) encourage routine maintenance to increase safety of lifts;

(ii) encourage routine maintenance to improve energy efficiency and/or operability of lifts;

(iii) improve lift consumer information by clarifying responsibility for routine maintenance and consequences of failing to perform routine lift maintenance;

(iv) increase lift safety and security by limiting the ability to reset indicator(s) to certain individuals (for example, individuals having special tools needed to open the indicator housing); and/or

(v) encourage lift maintenance, and thereby enhance lift efficiency and safety, by limiting operation of the lift until a lift maintenance technician performs routine maintenance required due to passage of a predetermined amount of time and/or lift usage.

### BRIEF DESCRIPTION OF THE DRAWINGS

The present invention will be more fully understood and appreciated by reading the following Detailed Description in conjunction with the accompanying drawings, in which:

FIG. 1 is a side view of first embodiment of a theatrical lift system according to the present invention with an indicator housing portion shown in cross section;

FIG. 2 is another cross sectional view of the indicator housing of the first embodiment lift system;

FIG. 3 is a perspective view of a second embodiment of a theatrical lift system according to the present invention; and

FIG. 4 is a block diagram of a third embodiment of a lift system according to the present invention.

### DETAILED DESCRIPTION OF THE INVENTION

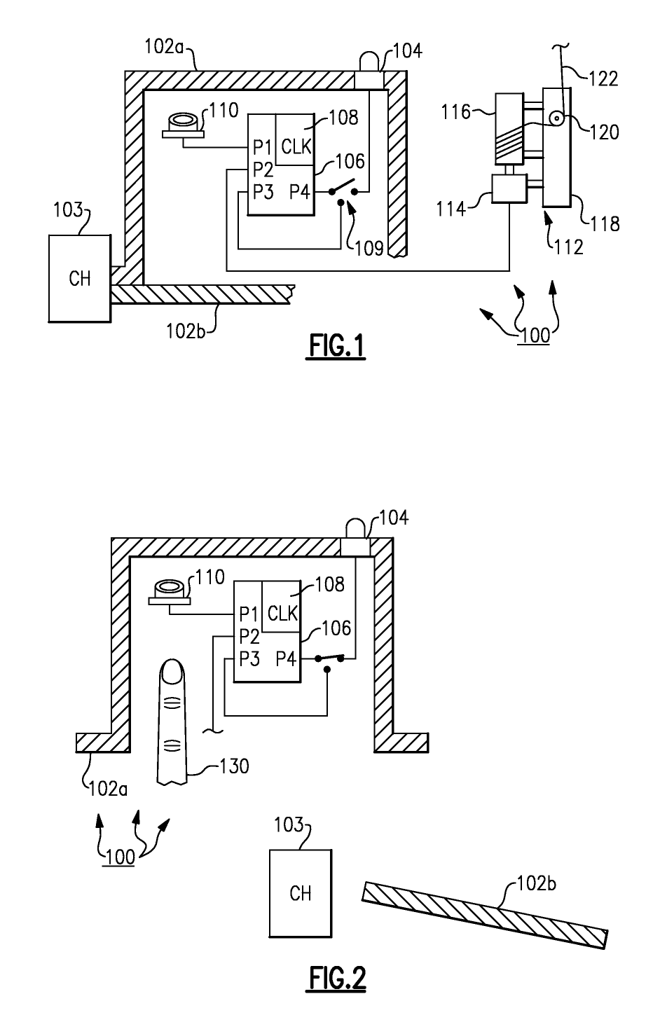

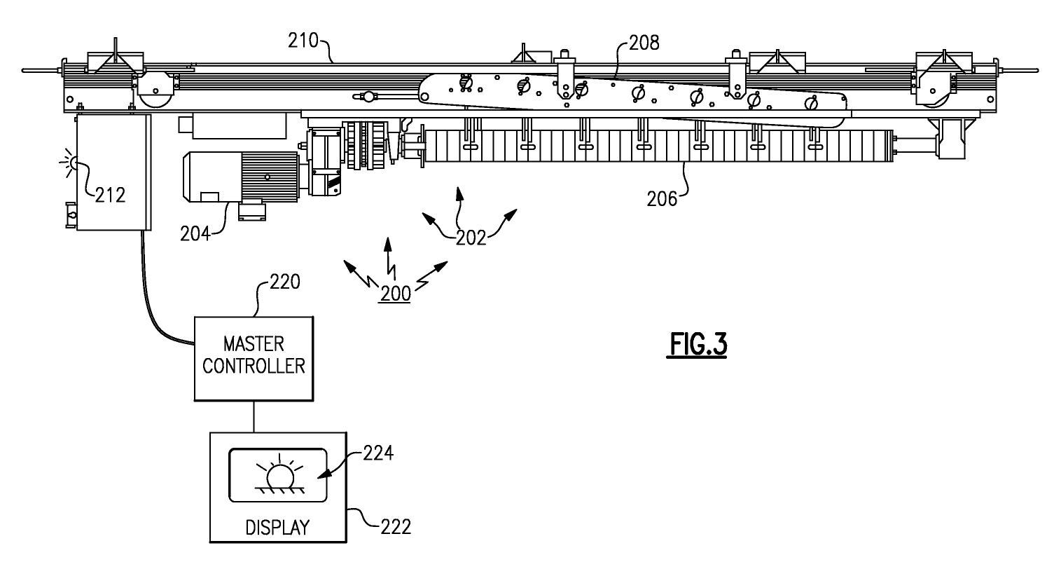

As shown in FIGS. 1 and 2 theatrical lift system 100 according to the present invention includes: controller housing 102; connection hardware 103; indicator LED 104; controller programmable logic circuitry 106; light on/off switch 109; timer reset 110; lift motor and gear train 114; drum 116; frame 118; head sheave 120 and cable 122. Circuitry 106 includes: ports P1, P2, P3, P4; and timer circuitry portion 108. The timer is programmed to measure a predetermined time interval. During this time interval: (i) light on/off switch 109 remains in the off position so that LED 104 remains off; (ii) circuitry 106 provides electronic control of the mechanical lift components 114, 116, 120, 122 through port P2; and (iii) routine maintenance is not yet required. After the predetermined interval of time passes: (i) circuitry 106 causes an appropriate signal to go out over P3 to close light on/off switch 109; and (ii) when light on/off switch closes, LED 104 receives power and goes on.

As shown in FIG. 2, routine maintenance includes opening up housing 102 from the closed (that is, no-access) position of FIG. 1 to the open (that is, access) position of FIG. 2. In the open position, the maintenance person 130 can access reset timer 110. In some embodiments a tool may be required to reset the timer without disturbing other components in the controller housing. By manually activating the reset timer mechanism: (i) circuitry 106 causes an appropriate signal to go out over P3 to re-open light on/off switch 109; (ii) when light on/off switch re-opens, LED 104 stops receiving power and goes off; and (iii) clock 108 starts counting another predetermined time interval until the next routine maintenance is called for. The next predetermined time interval may or may not be the same as the first depending upon recommended routine maintenance periods for the type of mechanical lift involved. The cycle of the maintenance LED going on and off and the resetting of timer 108 repeats indefinitely for the whole service life of mechanical lift system 100.

In some embodiments of the present invention, connection hardware will not require special tools to remove and may include, for examples: Manually operated latches; screw and nut assemblies; and/or magnetic closures. In other embodiments of the present invention, special tools may be required to manipulate the connection hardware 103 in order to open up controller housing 102. In some embodiments, the controller housing may not be in the form of housing member 102a and removable lid 102b. For example, the housing could include a window that is moved between an access and non-access position to selectively provide access to the reset mechanism. As a further example, the reset mechanism could be mounted to the lid (for example, mounted to a circuitry board which is mounted to the lid) so that the access is provided when the lid and reset mechanism are pulled away from the rest of the housing.

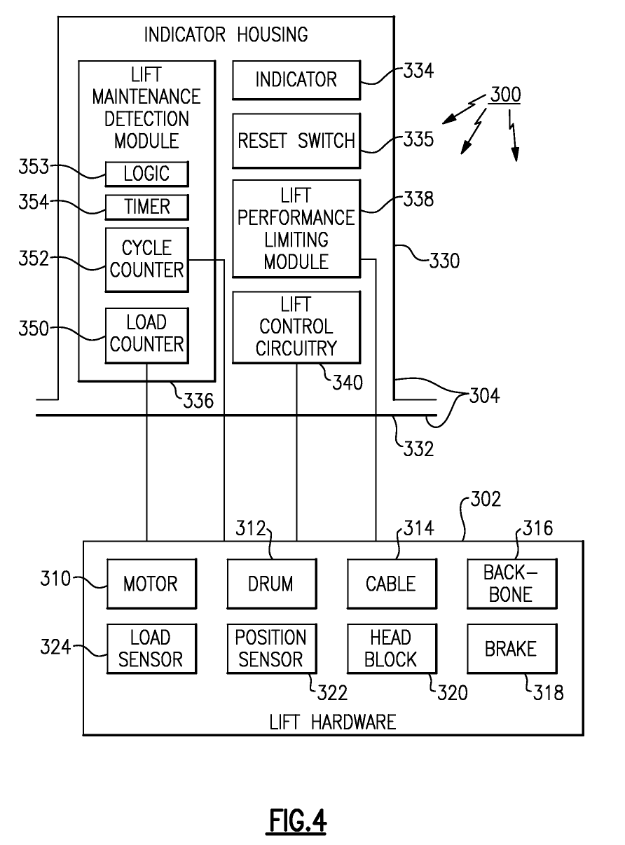

FIG. 3 shows lift system 200 according to the present invention including: lift hardware 202; indicator LED 212; master controller computer 220; and display 222. Lift hardware includes motor 204; drum 206; head block assembly 208 and backbone 210. The indicator LED could alternatively be put in locations other than where it is shown in FIG. 3. Preferably, the indicator LED should be placed where it is easy to see and not obscured by lift hardware components. As shown in FIG. 3, in addition to the indicator LED, lift 200 also provides visual indication 224 on its display 222. Display 222 may be, for example, an LCD display. As will be appreciated from FIG. 3, it is possible to mechanically connect (see DEFINITIONS section) an indicator to the lift hardware (indicator LED 212 is an example of this), provide an indicator remote to the rest of the lift hardware (indication on display 222 is an example of this), or to do both.

FIG. 4 shows lift system 300 according to the present invention including: lift hardware 302 and indicator housing assembly 304. Lift hardware 302 includes motor 310; drum 312; cable 314; backbone 316; load sensor 324; position sensor 322; head block 320; and brake 318. Indicator housing assembly 304 includes: indicator 334; reset switch 335; lift maintenance detection module 336; lift performance limiting module 338; and lift control circuitry 340. Lift maintenance detection module 336 includes: logic sub-module 353; timer sub-module 354; cycle counter sub-module 352; and load counter sub-module 350.

Generally speaking, the lift maintenance detection module determines when lift maintenance is required. The load sensor and position sensor provide lift operation data to the lift maintenance detection module for use in detecting when maintenance is required. For example, the cycle counter uses positional data to determine the number of lifting cycles that lift 300 performs. As a further example, the load counter aggregates the lift loading over time to determine lift usage in terms of loading forces exerted over time. The logic sub-module uses one or more of these determinations in combination with the timer to determine when various kinds of maintenance are required and to cause the indicator to indicate that fact to lift users.

Lift performance limiting module 338 limits lift performance in some way(s) after the lift maintenance detection module determines that it is time for lift maintenance. A non-exhaustive list of possible ways that lift performance may be limited is set forth above in the BRIEF SUMMARY section of this document. In preferred embodiments of the present invention, any lift performance limitations should be both: (i) sufficiently non-intrusive so that theatrical performances can be performed without the audience realizing that any lift performance limitation(s) have occurred; but (ii) sufficiently intrusive so that the lift operator will be motivated to get lift maintenance performed like she should. The performance may become more and more limited over time as the urgency of performing the maintenance increases.

### Definitions

The following definitions are provided to facilitate claim interpretation and claim construction:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, force fit connections, friction fit connections, connections secured by engagement added by gravitational forces, quick-release connections, pivoting or rotatable connections, slidable mechanical connections, latches and/or magnetic connections).

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Theatrical lift: lifts designed at least primarily for theatrical applications.

Special tool: a tool not commonly possessed by the average layperson; special tools do not need to be especially designed for a specific lift; for example, an Allen wrench with a square cross-section can be considered as a “special tool.”

Indicator: any hardware capable of providing an indication to a human or machine, including, but not necessarily limited to visual indications, buzzers, sound indications, etc.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A theatrical lift comprising:
lift hardware for lifting object(s);
a timer mechanically connected to the lift hardware, with the timer being structured and/or programmed to measure at least a first predetermined time interval, with the first predetermined time interval corresponding to a time for lift maintenance; and
an indicator in data communication connection with the timer, with the indicator being structured and/or programmed to provide an indication after the first predetermined time interval has passed.

2. The theatrical lift of claim 1 wherein with the first predetermined time interval corresponds to a time for routine lift maintenance.

3. The theatrical lift of claim 1 where the indicator comprises an indicator light.

4. The theatrical lift of claim 1 further comprising programmable logic circuitry structured and/or programmed to control operations of the lift, with the timer being programmed into the programmable logic circuitry.

5. The theatrical lift of claim 4 wherein:
the programmable logic circuitry comprises a board; and
the indicator comprises a board mounted LED.

6. The theatrical lift of claim 1 wherein:
the lift hardware comprises a lift circuitry housing;
the timer is located within the lift circuitry housing; and
the indicator is located on the lift circuitry housing.

7. The theatrical lift of claim 6 further comprising lift control circuitry structured and/or programmed to control operation of the lift hardware;
wherein the lift control circuitry is located within the lift circuitry housing.

8. The theatrical lift of claim 1 wherein:
the indicator comprises an LCD display screen; and
the indication comprises an interactive display on the LCD screen.

9. The theatrical lift of claim 1 wherein the indicator is located remotely from the lift hardware.

10. A lift comprising:
lift hardware for lifting object(s);
a lift maintenance detection module connected to the lift hardware, with the lift maintenance detection module being structured and/or programmed to determine when it is a time for lift maintenance;
a reset mechanism structured, connected and/or programmed to at least partially reset the lift maintenance detection module; and
an indicator housing, with the reset mechanism being located within the indicator housing, and with the indicator housing being movable between a non-access position and an access position so that: (i) when the indicator housing is in the non-access position, the reset mechanism cannot be accessed from outside of the indicator housing; and (ii) when the indicator housing is in the access position, the reset mechanism can be accessed from outside of the indicator housing.

11. The lift of claim 10 wherein:
the indicator housing comprises a removable lid and a housing member;
the indicator housing is in the non-access position when the lid is detachably attached to the housing member; and
the indicator housing is in the non-access position when the lid is removed from the housing member.

12. The lift of claim 10 wherein special tools are required to move the indicator housing from the non-access position into the access position.

13. The lift of claim 10 wherein the lift maintenance detection module comprises a timer located in the lift housing, with the timer being resettable by the reset mechanism.

14. The lift of claim 10 wherein the reset mechanism is a mechanically operable switch.

15. The lift of claim 10 further comprising lift control circuitry structured and/or programmed to control operation of the lift hardware;
wherein the lift control circuitry is located within the indicator housing.

16. A theatrical lift comprising:
lift hardware for lifting object(s);
a lift maintenance detection module connected to the lift hardware, with the lift maintenance detection module being structured and/or programmed to determine when it is a time for lift maintenance; and
a lift performance limiting module in data communication connection with the lift maintenance detection module, with the lift performance limiting module being structured and/or programmed to limit lift performance after the lift maintenance detection module determines that it is time for lift maintenance.

17. The lift of claim 16 wherein the lift maintenance detection module comprises a timer for measuring at least a first predetermined time interval, with the determination of the time for lift maintenance being at least partially based upon the first predetermined time interval.

18. The lift of claim 16 wherein the lift maintenance detection module comprises a lift usage detection sub-module for measuring at least a first aspect of lift usage, with the determination of the time for lift maintenance being at least partially based upon the first aspect of lift usage measured by the lift usage detection sub-module.

19. The lift of claim 16 wherein the lift performance limiting module is structured and/or programmed to limit lift performance in at least one of the following ways: (i) lift start up time increased; (ii) lift shut down time increased; (iii) delay intervals added to non-emergency manual operations of the lift; (iv) range of lift motion reduced; (v) maximum load reduced; and/or (vi) maximum speed reduced.

20. The lift of claim 16 wherein the lift performance limiting module is structured and/or programmed to limit lift performance by rendering the lift completely inoperable.
